(19) United States
(12) Patent Application Publication
(10) Pub. No.: US 2024/0122778 A1
(43) Pub. Date: Apr. 18, 2024

(54) DEVICE FOR UPPER LIMB REHABILITATION

(71) Applicant: De La Salle University, Manila (PH)

(72) Inventors: Nilo T. Bugtai, Manila (PH); Jade R. Dungao, Manila (PH); Renann G. Baldovino, Manila (PH); Alexander C. Abad, Manila (PH); Paul Dominick E. Baniqued, Manila (PH); Aira Patrice R. Ong, Manila (PH); Michael V. Manguerra, Manila (PH); Voltaire B. Dupo, Laguna (PH); Winny M. Paredes, Manila (PH); Maria Annyssa Z. Perez, Manila (PH); Carlos Matthew P. Cases, Parañaque City (PH); Eldrich Bong B. Valencerina, Pangasinan (PH); Hanz Emmanuel A. Timbre, Laguna (PH); Christopher S. Constantino, Manila (PH); Jeremy O. Flordelis, Cebu City (PH); Jose Alvin P. Mojica, Manila (PH)

(73) Assignee: De La Salle University, Manila (PH)

(21) Appl. No.: 17/293,820

(22) PCT Filed: Nov. 13, 2019
(86) PCT No.: PCT/PH2019/000010

§ 371 Date: May 13, 2021

(30) Foreign Application Priority Data
Nov. 14, 2018 (PH) 12018000369

(51) Int. Cl. A61H 1/02

(52) U.S. Cl. CPC A61H 1/0277; A61H 1/0281; A61H 2001/0203; A61H 2201/1215; A61H 2201/1614; A61H 2201/1671

(57) ABSTRACT

A device for rehabilitation of the upper limb includes a frame and an exoskeleton mounted on the frame. The exoskeleton has a first joint coupled to the frame, a first L-shaped connector connecting the first joint to a second joint, a second L-shaped connector connecting the second joint to a third joint, and an attaching member attaching an upper limb of a human subject to the exoskeleton. The first joint is situated above a shoulder of the human subject and has a first axis of rotation substantially coinciding with the horizontal abduction/adduction rotation axis of the shoulder. The second joint is situated behind the shoulder and has a second axis of rotation coinciding with the abduction/adduction rotation axis of the shoulder. The third joint is situated at the side of the shoulder and has a third axis of rotation substantially coinciding with the flexion/extension rotation axis of the shoulder.

### FIELD OF THE INVENTION

The present invention relates to exoskeletons for rehabilitation of a human upper limb.

### DESCRIPTION OF THE RELATED ART

Stroke and injury remain the two leading causes of disability in the Philippines. Recent technological advances in biomedical engineering have paved the way for the development of exoskeletons for rehabilitation. However, a low-cost device that can effectively increase upper extremity motor recovery remains unavailable in developing regions that have limited access to modern healthcare facilities.

Several patent documents teach robotic exoskeleton devices for upper limb rehabilitation through assisted movement of the human shoulder and the human elbow.

CN108210246 discloses a four-degree-of-freedom rehabilitation mechanical arm device comprising a base and a rehabilitation mechanical arm mounted on the base. The rehabilitation mechanical arm includes a shoulder abduction joint, a shoulder flexion and extension joint connected to the shoulder abduction joint, an elbow flexion and extension joint, and a wrist flexion and extension joint.

A joint compound motion mechanical arm disclosed in CN106038175 includes an auxiliary movement system fixed to a main fixation seat. The auxiliary movement system comprises a first joint motion mechanism for assisting the shoulder joint for adduction and abduction, a second joint motion mechanism for assisting the shoulder joint for flexion and extension motion, and a third joint motion mechanism for assisting the elbow joint in flexion and extension. Neither the device of CN108210246 nor the arm of CN106038175 appears to be effective in assisting in the horizontal abduction/adduction movement of a human shoulder.

An upper limb rehabilitation robot is disclosed in CN107854813. The robot has joint modules each including a direct current motor, a harmonic reducer, a brake, and an encoder. The joint modules realize seven degrees of freedom: two degrees of freedom for the shoulder blades, three degrees of freedom for the shoulder joint, one degree of freedom for the elbow joint, and one degree of freedom for the forearm.

CN105853141 teaches a shoulder rehabilitation system having a main body provided with three rotating components and a gravity compensation mechanism. The three rotating components of the main body realize three degrees of freedom for the shoulder joint: internal/outer rotation, abduction/adduction, and flexion/extension.

The arm exoskeleton of WO2016187636 comprises a wrist module, an elbow joint module, an upper arm rotation module, and a shoulder module. The modules are connected to each other via rods. Each module includes at least one drive for moving a joint of a user's arm. The shoulder module has two joint actuators to perform shoulder elevation and rotation. The elbow joint module has an elbow drive for movement of the user's elbow. Rotation of the upper arm is accomplished via a drive on the upper arm module.

WO2015058249 discloses a robotic exoskeleton apparatus that includes a base, links, and revolute joints. The first, second, and third revolute joints cooperate to provide three degrees of freedom for a human shoulder. A fourth revolute joint provides a redundant degree of freedom to facilitate control of the apparatus. A disadvantage of the apparatus is that the first revolute joint is adjacent to a shoulder or upper arm of a user. Such an arrangement would force the first revolute joint to bear the weight of the apparatus, which may damage the joint.

The object of the present invention is to provide an exoskeleton having three degrees of freedom accounting for shoulder movements. Another object of the invention is to provide an exoskeleton having four degrees of freedom accounting for shoulder and elbow movements. The device of the present invention has an arrangement of joints and links that is novel and inventive over the prior art. is comfortable, user-friendly, safe-to-use, and can be manufactured at a relatively low cost.

### SUMMARY OF THE INVENTION

According to this invention, a device for rehabilitation of the upper limb comprises a frame and an exoskeleton mounted on the frame. The exoskeleton includes a first joint, a second joint, a third joint, and at least one attaching means. The first joint is coupled to the frame and is configured to be situated above a shoulder of a human subject. The first joint has a first axis of rotation substantially coinciding with the horizontal abduction/adduction rotation axis of the shoulder of the human subject. The second joint is connected to the first joint by a first L-shaped connector and is configured to be situated behind the shoulder of the human subject. The second joint has a second axis of rotation coinciding with the abduction/adduction rotation axis of the shoulder of the human subject. The third joint is connected to the second joint by a second L-shaped connector and is configured to be situated at the side of the shoulder of the human subject. The third joint has a third axis of rotation substantially coinciding with the flexion/extension rotation axis of the shoulder of the human subject. The attaching means attaches at least a part of the upper limb of the human subject to the exoskeleton.

In one embodiment, the exoskeleton further includes an elbow joint coupled to the third joint by a telescopic link. The elbow joint has a fourth axis of rotation substantially coinciding with the flexion/extension rotation axis of an elbow of the human subject.

In one embodiment, at least one of the first joint, the second joint, the third joint, and the elbow joint of the exoskeleton is a motor-driven actuator.

In one embodiment, the first L-shaped connector includes a first horizontal section connected to the first joint and a first vertical section extending downwardly from the first horizontal section and connected to the second joint.

In one embodiment, the second L-shaped connector includes a laterally extending segment connected to the second joint and a forwardly extending segment extending forwardly from the laterally extending segment and connected to the third joint.

In one embodiment, the frame of the device is a wheeled frame.

### BRIEF DESCRIPTION OF THE DRAWINGS

Other features and advantages of the invention will become apparent in the following detailed description of the embodiment with reference to the accompanying drawings, of which:

FIGS. 1a and 1b are perspective views of an embodiment of a device for upper limb rehabilitation according to the invention viewed from different angles.

FIG. 2a is a perspective view of an embodiment of an exoskeleton according to the invention. FIG. 2b is an exploded view of the embodiment of the exoskeleton in FIG. 2a.

FIGS. 3a, 3b, 3c, and 3d are schematic diagrams illustrating rotation axes and motions of a human shoulder and a human elbow. FIG. 3a shows the horizontal abduction/adduction rotation axis and the horizontal abduction/adduction motion of the shoulder of the human subject. FIG. 3b shows the abduction/adduction rotation axis and the abduction/adduction motion of the shoulder of the human subject. FIG. 3c shows the flexion/extension rotation axis and the flexion/extension motion of the shoulder of the human subject. FIG. 3d shows the flexion/extension rotation axis and the flexion/extension motion of the elbow of the human subject.

FIG. 4 is a perspective view of an embodiment of a device for upper limb rehabilitation, in a state of use, according to the invention.

### DESCRIPTION OF THE EMBODIMENT

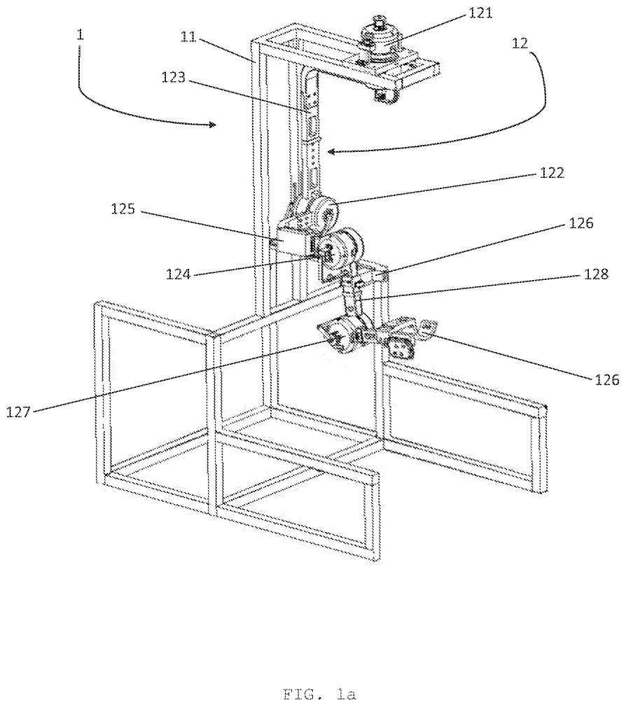

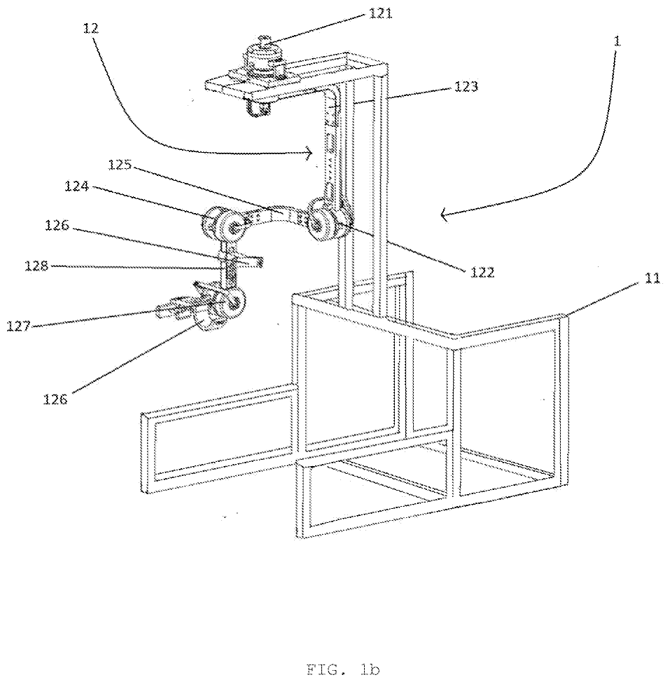

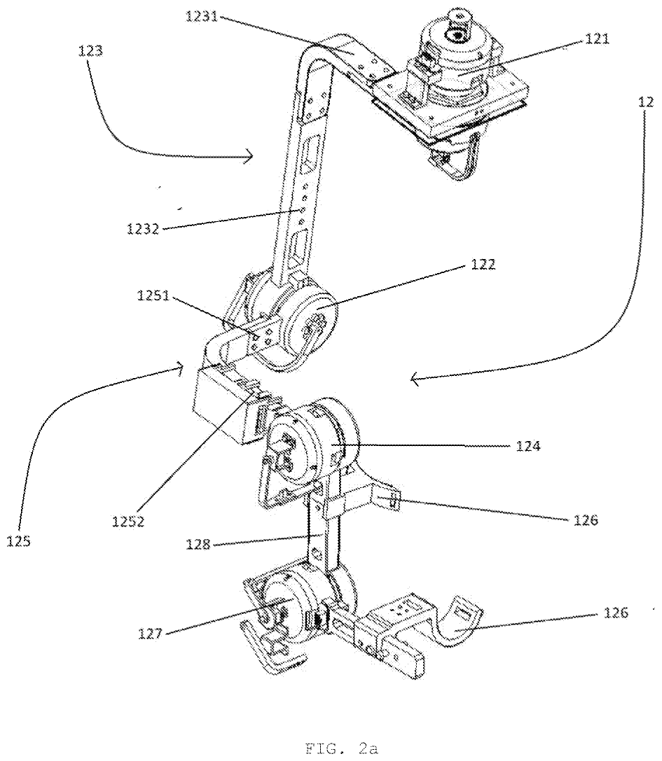

With reference to FIGS. 1a and 1b a device (1) for rehabilitation of the upper limb comprises a frame (11) and an exoskeleton (12). The exoskeleton (12) is mounted on the frame (11), which bears the weight of the exoskeleton (12). The exoskeleton (12) includes a first joint (121) coupled to the frame (11), a second joint (122), a first L-shaped connector (123) that connects the first joint (121) to the second joint (122), a third joint (124), a second L-shaped connector (125) that connects the second joint (122) to the third joint (124), and at least one attaching means (126) for attaching at least a part of the upper limb to the exoskeleton (12). The first L-shaped connector (123) can be screwed to the first joint (121) on one end and screwed on the other end to the second joint (122). The second L-shaped connector (125) can be screwed to the second joint (122) on one end and screwed on the other end to the third joint (124). In this embodiment, the exoskeleton (12) further includes an elbow joint (17) coupled to the third joint (124) by a telescopic link (128). The attaching means (126) can be a brace that attaches the upper arm of a human subject to the telescopic link (128). The attaching means (126) can also be a brace with straps that attach the forearm of the human subject to a portion of the elbow joint (127). The exoskeleton (12) may have more than one attaching means (126).

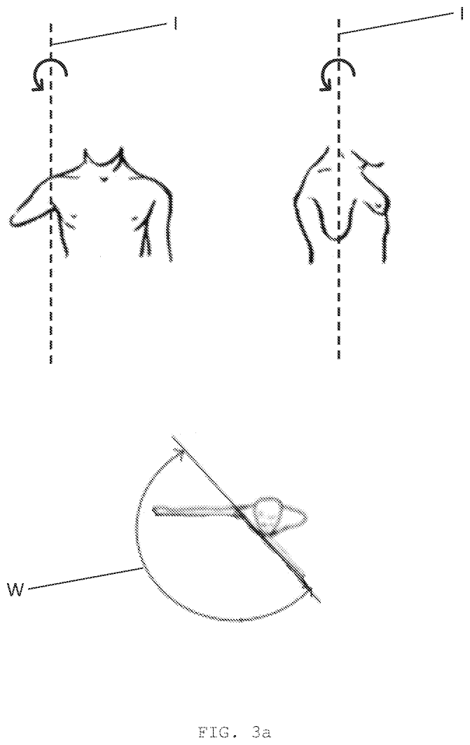

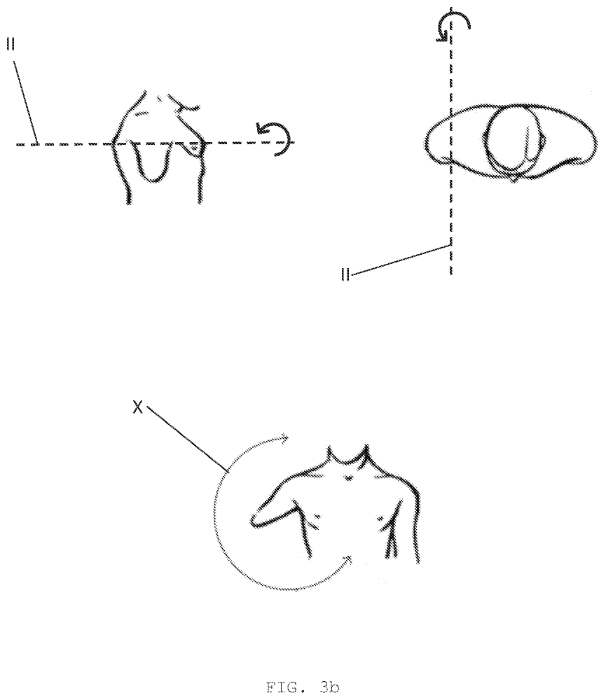

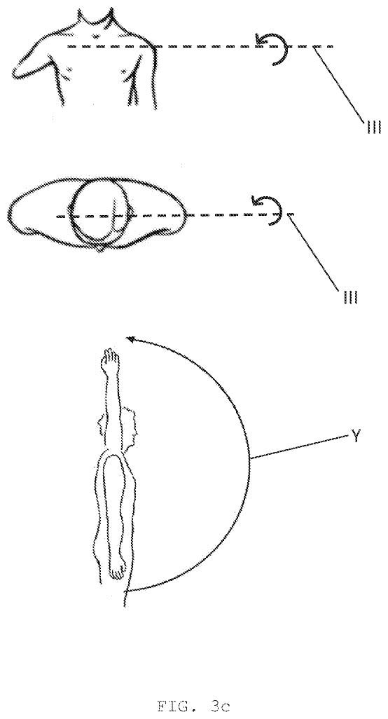

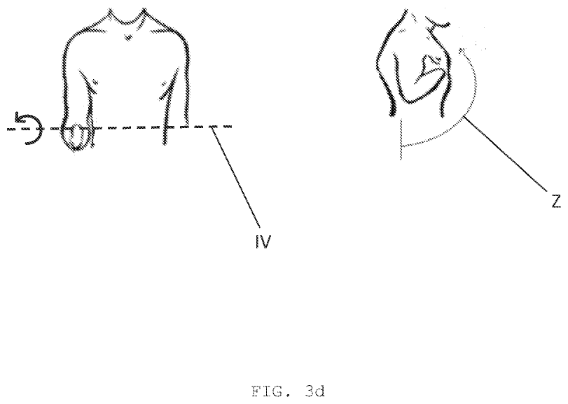

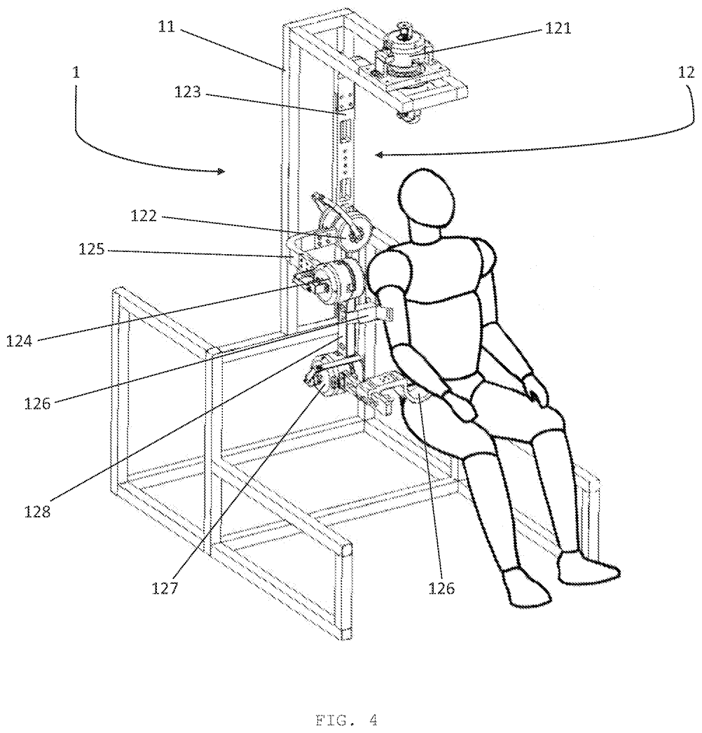

With reference to FIGS. 3a, 3b, 3c, 3d, and 4, the first joint (121) is configured to be situated above a shoulder of the human subject and has a first axis of rotation substantially coinciding with the horizontal abduction/adduction rotation axis (I) of the shoulder of the human subject. The first joint (121) assists the human subject in performing the shoulder horizontal abduction/adduction motion (W). The second joint (122) is configured to be situated behind the shoulder of the human subject and has a second axis of rotation coinciding with the abduction/adduction rotation axis (II) of the shoulder of the human subject. The second joint (122) assists the human subject in performing the shoulder abduction/adduction motion (X). The third joint (124) is configured to be situated at the side of the shoulder of the human subject and has a third axis of rotation substantially coinciding with the flexion/extension rotation axis (III) of the shoulder of the human subject. The third joint (124) assists the human subject in performing the shoulder flexion/extension motion (Y). The elbow joint (127) has a fourth axis of rotation substantially coinciding with the flexion/extension rotation axis (IV) of an elbow of the human subject. The elbow joint (127) assists the human subject in performing the elbow flexion/extension motion (Z).

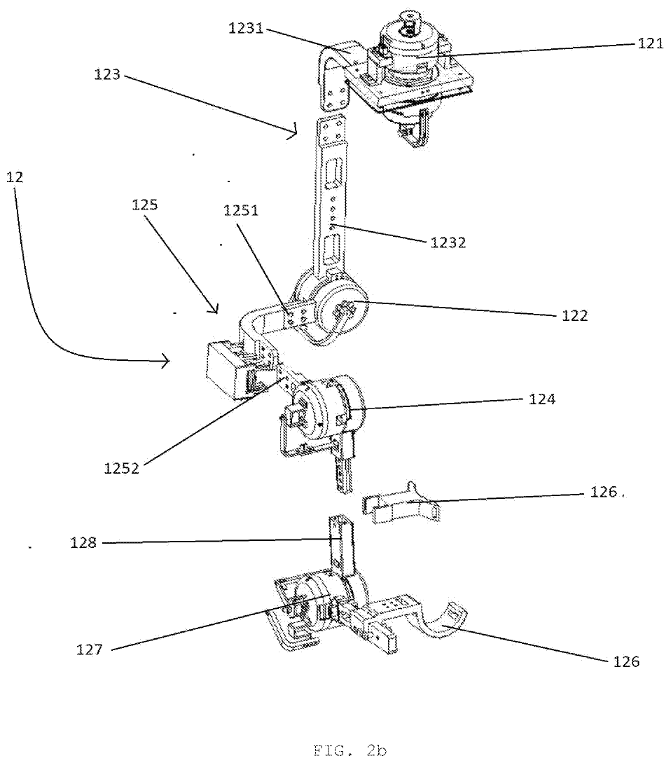

As shown in FIGS. 2a and 2b, the first L-shaped connector (123) includes a first horizontal section (1231) connected to the first joint (121) and a first vertical section (1232) extending downwardly from the first horizontal section (1231) and connected to the second joint (122). The second L-shaped connector (125) includes a laterally extending segment (1251) connected to the second joint (122) and a forwardly extending segment (1252) extending forwardly from the laterally extending segment (1251) and connected to the third joint (124).

In one embodiment of the exoskeleton (12) of this invention, at least one of the first joint (121), the second joint (122), the third joint (124), and the elbow joint (127), is a motor-driven actuator. For example, the first joint (121) may be an embodiment of a motor-driven actuator assembly disclosed in PH/2018/283133, which was filed at the Intellectual Property Office of the Philippines on 6 Sep. 2018. Use of the said motor-driven actuator assembly would transfer the axial load attributed to the weight of the exoskeleton (12) to the frame (11), reducing the strain on the first joint (121). The arrangement would allow for the use of different kinds of motors, including motors designed to optimally provide torque on a horizontal axis.

In some embodiments, the frame (11) of the device (1) may be a wheeled frame, allowing easy movement of the device (1) from one location to another.

1. A device for rehabilitation of the upper limb of an associated human subject, comprising:
a frame; and
an exoskeleton mounted on the frame, the exoskeleton including:
a first joint coupled to the frame, the first joint configured to be situated above a shoulder of the associated human subject and having a first axis of rotation substantially coinciding with the horizontal abduction/adduction rotation axis (I) of the shoulder of the associated human subject;
a second joint configured to be situated behind the shoulder of the human subject and having a second axis of rotation coinciding with the abduction/adduction rotation axis (II) of the shoulder of the associated human subject;
a first L-shaped connector that connects the first joint to the second joint;
a third joint configured to be situated at the side of the shoulder of the associated human subject and having a third axis of rotation substantially coinciding with the flexion/extension rotation axis (III) of the shoulder of the associated human subject;
a second L-shaped connector that connects the second joint to the third joint; and
at least one attaching means for attaching at least a part of the upper limb of the associated human subject to the exoskeleton.

2. The device according to claim 1, wherein the exoskeleton further includes a telescopic link coupled to the third joint, and an elbow joint coupled to the third joint and having a fourth axis of rotation substantially coinciding with the flexion/extension rotation axis (IV) of an elbow of the associated human subject.

3. The device according to claim 1, wherein at least one of the first joint, the second joint, the third joint, and the elbow joint, is a motor-driven actuator.

4. The device according to claim 1, wherein the first L-shaped connector includes a first horizontal section connected to the first joint and a first vertical section extending downwardly from the first horizontal section and connected to the second joint.

5. The device according to claim 1, wherein the second L-shaped connector includes a laterally extending segment connected to the second joint and a forwardly extending segment extending forwardly from the laterally extending segment and connected to the third joint.

6. The device according to claim 1, wherein the frame is a wheeled frame.
